(19) United States
(12) Patent Application Publication
(10) Pub. No.: US 2014/0280542 A1
(43) Pub. Date: Sep. 18, 2014

(54) SOCIAL COMPETITION ENGINE

(71) Applicants: Keenan Pridmore, Chicago, IL (US); Philip John MacGregor, Chicago, IL (US); Christopher Barbour, Mountain View, CA (US)

(72) Inventors: Keenan Pridmore, Chicago, IL (US); Philip John MacGregor, Chicago, IL (US); Christopher Barbour, Mountain View, CA (US)

(21) Appl. No.: 13/829,401

(22) Filed: Mar. 14, 2013

(51) Int. Cl. H04L 29/08

(52) U.S. Cl. CPC H04L 67/22
USPC 709/204

(57) ABSTRACT

A method in a social networking system enables social competition between its users. The method includes receiving, from a user device of a user, a challenge creation request message, which includes a challenge indication describing a competition that a set of users may participate in, a challenge stakes indication describing at least one of an award for a winner of the competition and a consequence for losers of the competition, and a set of user identifiers for the set of users. The social networking system notifies the set of users about the competition, receives challenge acceptance messages from some of the users, receives a challenge completion message indicating the winner of the competition, and receives evidence indicating a fulfillment of the challenge stakes. The social networking system transmits information about the competition to a set of one or more user devices of a second set of users.

### FIELD

Embodiments of the invention relate to social networking; and more specifically, to enabling social competition for users of a social networking system using a social competition engine.

### BACKGROUND

The development of social networking has allowed humans to easily share information of a personal nature. Social networking systems allow users to designate other users as friends (or otherwise connect to or form relationships with other users), contribute and interact with media items, use applications, join groups, list and confirm attendance at events, create pages, and perform other tasks that facilitate social interaction.

However, developers of social networking systems continually strive to incorporate more “real world” human behavior in the realm of social networks to improve social connections between its users, especially in a mobile world where people often live or work far away from friends and family. Accordingly, finding ways to bring more typical real world interactions into the framework of social networks is of the utmost of importance.

### BRIEF DESCRIPTION OF THE DRAWINGS

The invention may best be understood by referring to the following description and accompanying drawings that are used to illustrate embodiments of the invention. In the drawings:

FIG. 1 is a network diagram of one embodiment of a system for providing personalized content to a user of a social networking system;

FIG. 2 is a diagram of one embodiment of a social networking system;

FIG. 3 is a sequence diagram illustrating a social competition enabled by a social competition engine of a social networking system according to one embodiment of the invention;

FIG. 4 illustrates a user device displaying a user interface for creating a social challenge according to one embodiment of the invention using a social networking system including a social competition engine module;

FIG. 5 illustrates a user device displaying a user interface for inviting friends to a join a social challenge according to one embodiment of the invention using a social networking system including a social competition engine module;

FIG. 6 illustrates a user device displaying a user interface for a social challenge notification according to one embodiment of the invention using a social networking system including a social competition engine module;

FIG. 7 illustrates a user device displaying a user interface for a social challenge according to one embodiment of the invention using a social networking system including a social competition engine module;

FIG. 8 illustrates a user device displaying a user interface for a winner of a social challenge according to one embodiment of the invention using a social networking system including a social competition engine module;

FIG. 9 illustrates a user device displaying a user interface for a loser of a social challenge according to one embodiment of the invention using a social networking system including a social competition engine module;

FIG. 10 illustrates a plurality of social graph stories in a social networking system according to one embodiment of the invention;

FIG. 11 illustrates a social graph challenge completion story and a challenge proposal story in a social networking system according to one embodiment of the invention;

FIG. 12 illustrates a flow for enabling social competition between users of a social networking system according to one embodiment of the invention;

FIG. 13 illustrates a flow for enabling social competition for a user of a social networking system according to one embodiment of the invention; and

FIG. 14 illustrates, in block diagram form, an exemplary processing system according to one embodiment of the invention.

### DESCRIPTION OF EMBODIMENTS

In the following description, numerous specific details are set forth. However, it is understood that embodiments of the invention may be practiced without these specific details. References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Detailed below are embodiments of methods, systems, and apparatuses for enabling social competition for users of a social networking system using a social competition engine. The social competition engine described herein allows social networking system users (including entities such as businesses) to turn small competitions into “high stakes” competitive spectacles visible to their friends and family through the social networking system. Users may propose social competitions with a set of stakes, invite other users to participate in the competitions, observe and discuss the competitions, and upload and/or view multimedia content documenting the competition or providing evidence of fulfillment of the stakes upon the completion of the competition. Users may also participate in open-invite social competitions proposed by other people or organizations.

FIG. 1 is a network diagram of one embodiment of a system 100 for providing personalized content to a user of a social networking system 130. The system 100 includes one or more user devices 110, one or more third-party websites 120, the social networking system 130 and a network 140. For purposes of illustration, the embodiment of the system 100 shown by FIG. 1 includes a single third-party website 120 and a single user device 110. However, in other embodiments, the system 100 may include more user devices 110 and/or more third-party websites 120. In certain embodiments, the social networking system 130 is operated by the social network provider, whereas the third-party websites 120 are separate from the social networking system 130 in that they may be operated by different entities. In various embodiments, however, the social networking system 130 and the third-party websites 120 operate in conjunction to provide social networking services to users of the social networking system 130. In this sense, the social networking system 130 provides a platform, or backbone, which other systems, such as third-party websites 120, may use to provide social networking services and functionalities to users across the Internet.

Users of a social networking system may be individual persons, fictional persons, groups of individual people, or other entities such as organizations, non-profit groups, corporations, companies, etc.

The user device 110 comprises one or more computing devices that can receive input from a user and can transmit and receive data via the network 140. For example, the user device 110 may be a desktop computer, a laptop computer, a smart phone, a personal digital assistant (PDA), or any other device including computing functionality and data communication capabilities. The user device 110 is configured to communicate with the third-party website 120 and the social networking system 130 via the network 140, which may comprise any combination of local area networks (LANs) and/or wide area networks (WANs), using both wired and wireless communication systems.

In one embodiment, the user device 110 displays content from the third-party website 120 or from the social networking system 130 by processing a markup language document 116 received from the third-party website 120 or from the social networking system 130 using a browser application 112. The markup language document 116 identifies content and one or more instructions describing formatting or presentation of the content. By executing the instructions included in the markup language document 116, the browser application 112 displays the identified content using the format or presentation described by the markup language document 116. For example, the markup language document 116 includes instructions for generating and displaying a web page having multiple frames that include text and/or image data retrieved from the third-party website 120 and/or the social networking system 130. In various embodiments, the markup language document 116 comprises a data file including extensible markup language (XML) data, extensible hypertext markup language (XHTML) data or other markup language data.

In one embodiment where the user device 110 is a mobile device such as a smart phone or tablet, the user device 110 also includes one or more mobile applications 118 that execute on the user device 110. The mobile application 118 may execute as an independent stand-alone application or may utilize the network 140 to exchange data between the user device 110, the social networking system 130 and/or the third-party website 120.

The third-party website 120 comprises one or more web servers including one or more web pages 122, which are communicated to the user device 110 using the network 140. The third-party website 120 is separate from the social networking system 130. For example, the third-party website 120 is associated with a first domain while the social networking website is associated with a separate social networking domain. A web page 122 included in the third-party website 120 comprises a markup language document identifying content and including instructions specifying formatting or presentation of the identified content, as described above. The social networking system 130 comprises one or more computing devices storing a social network, or mapping of a social graph, comprising a plurality of users and providing users of the social network with the ability to communicate and interact with other users of the social network. The social networking system 130 is further described below in conjunction with FIG. 2. In use, users of the social networking system 130 add connections to a number of other users of the social networking system 130 to whom they desire to be connected. As used herein, the term “friend” or the term “a connection” refers to any other user of the social networking system 130 to whom a user has formed a connection, association, or relationship via the social networking system 130.

Connections may be added explicitly by a user or may be automatically created by the social networking systems 130 based on common characteristics of the users (e.g., users who are alumni of the same educational institution). For example, a first user specifically selects a particular other user to be a friend. Connections in the social networking system 130 are usually in both directions, but need not be, so the terms “user,” “friend” and “connection” depend on the frame of reference. Connections between users of the social networking system 130 are usually bilateral, or “mutual,” but connections may also be unilateral, or “one-way.” For example, if Bob and Joe are both users of the social networking system 130 and connected to each other, Bob and Joe are each other's connections. If, on the other hand, Bob wishes to connect to Joe to view data communicated to the social networking system by Joe but Joe does not wish to form a mutual connection, a unilateral connection may be established. The connection between users may be a direct connection; however, some embodiments of a social networking system allow the connection to be indirect via one or more levels of connections or degrees or separation.

In addition to establishing and maintaining connections between users and allowing interactions between users, the social networking system 130 provides users with the ability to take actions on various types of items supported by the social networking system 130. These items may include groups or networks (where “networks” here refer not to physical communication networks, but rather social networks of people, entities, and concepts) to which users of the social networking system may belong, events or calendar entries in which a user might be interested, computer-based applications that a user may use via the social networking system 130, transactions that allow users to buy or sell items via the service, and interactions with advertisements that a user may perform on or off the social networking system. These are just a few examples of the items upon which a user may act on a social networking system, and many others are possible. A user may interact with anything that is capable of being represented in the social networking system 130 or in a third-party website 120, separate from the social networking system 130, coupled to the social networking system 130 via a network 140.

The social networking system 130 is also capable of connecting a variety of entities. For example, the social networking system 130 enables users to interact with each other as well as third-party websites 120 or other entities through an API or other communication channels.

The social networking system 130 also includes user-generated content, which enhances a user's interactions with the social networking system 130. User-generated content may include anything a user can add, upload, send, or “post,” to the social networking system 130. For example, a user communicates posts to the social networking system 130 from a user device 110. Posts may include data such as status updates or other textual data, location information, photos, videos, links, music or other similar data, content and/or media. Content may also be added to the social networking system 130 by a third-party through a “communication channel,” such as a newsfeed or stream. Content “items” represent single pieces of content that are represented as objects in the social networking system 130. In this way, users of the social networking system 130 are encouraged to communicate with each other by posting text and content items of various types of media through various communication channels, increasing the interaction of users with each other and increasing the frequency with which users interact within the social networking system 130.

FIG. 2 is a diagram of one embodiment of a social networking system 130. The embodiment of a social networking website 130 shown by FIG. 2 includes a web server 210, an action logger 215, an API request server 220, an action log 230, a user profile store 240, a connection store 245, and a social competition engine module 250. In other embodiments, the social networking website 130 may include additional, fewer, or different modules for various applications. Conventional components such as network interfaces, security mechanisms, load balancers, failover servers, management and network operations consoles, and the like are not shown so as to not obscure the details of the system.

As described above in conjunction with FIG. 1, the social networking system 130 comprises a computing system that allows users to communicate or otherwise interact with each other and access content as described herein. The social networking system 130 stores user profiles describing the users of a social network. The user profiles include biographic, demographic, and other types of descriptive information, such as work experience, educational history, hobbies or preferences, interests, location, and the like. The social networking system 130 further stores data describing one or more connections between different users in the connection store 245. The connection information may indicate users who have similar or common work experience, group memberships, hobbies, educational history, or are in any way related or share common attributes. Additionally, the social networking system 130 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed.

The web server 210 is one module used to link the social networking system 130 to one or more user devices 110 and/or one or more third-party websites 130 via the network 240. The web server 210 serves web pages, as well as other web-related content, such as Java, Flash, 12L, and so forth. The web server 210 may include a mail server or other messaging functionality for receiving and routing messages between the social networking system 130 and one or more user devices 110. The messages can be instant messages, queued messages (e.g., email), text and Short Message Service (SMS) messages, or any other suitable messaging format. However, the social networking system 130 may also interact with the one or more user devices 110 through a standalone application executing on each device, such as the mobile application 118.

The Application Programming Interface (API) request server 220 allows one or more third-party websites 120 and/or mobile applications 118 to access information from the social networking system 130 by calling one or more APIs. The API request server 220 may also allow third-party websites 120 and/or mobile applications 118 to send information to social networking website by calling APIs. For example, a third-party website 120 sends an API request to the social networking system 130 via the network 140 and the API request server 220 receives the API request. The API request server 220 processes the request by calling an API associated with the API request to generate an appropriate response, which the API request server 220 communicates to the third-party website 120 via the network 140. For example, responsive to an API request, the API request server 220 collects data associated with a user and communicates the collected data to the third-party website 120.

The action logger 215 is capable of receiving communications from the web server 210 about user actions on and/or off the social networking system 130. The action logger 215 populates the action log 230 with information about user actions, allowing the social networking system 130 to track various actions taken by its users within the social networking system 130 and outside of the social networking system 130. Any action that a particular user takes with respect to another user is associated with each user's profile, through information maintained in the action log 230 or in a similar database or other data repository. Examples of actions taken by a user within the social network 130 that are identified and stored may include, for example, adding a connection to another user, sending a message to another user, reading a message from another user, viewing content associated with another user, attending an event posted by another user or other actions interacting with another user. When a user takes an action within the social networking system 130, the action is recorded in an action log 240. In one embodiment, the social networking system maintains the action log 230 as a database of entries. When an action is taken within the social networking system 130, an entry for the action is added to the action log 230.

Additionally, user actions may be associated with an entity outside of the core social networking system 130, such as a third-party website 120 that is separate from the social networking system website 130. For example, the action logger 215 receives data describing a user's interaction with a third party website 120 from the web server 210. Examples of actions where a user interacts with a third-party website 120 includes a user expressing an interest in a third-party website 120 or another entity, a user posting a comment to the social networking system 130 that discusses a third-party website 120, or a web page 122 within the third-party website 120, a user posting to the social networking system 130 a Uniform Resource Locator (URL) or other identifier associated with a third-party website 120, a user attending an event associated with a third-party website 120 or any other action by a user that is related to a third-party website 120. Thus, the action log 240 may include actions describing interactions between a social networking system user and a third-party website 120 that is separate from the social networking system 130.

The authorization server 235 enforces one or more privacy settings of the users of the social networking system 130. A privacy setting of a user determines how particular information associated with a user can be shared. The privacy setting comprises the specification of particular information associated with a user and the specification of the entity or entities with whom the information can be shared. Examples of entities with which information can be shared may include other users, applications, mobile applications 118, third-party websites 120 or any entity that can potentially access the information. The information that can be shared by a user comprises user profile information like profile photo, phone numbers associated with the user, user's connections, actions taken by the user such as adding a connection, changing user profile information and the like.

The authorization server 235 contains logic to determine if certain information associated with a user can be accessed by a user's friends, third-party websites 120 and/or other applications and entities. For example, a third-party website 120 that attempts to access a user's comment about a URL associated with the third-party website 120 must get authorization from the authorization server 235 to access the user's work phone number. Based on the user's privacy settings, the authorization server 235 determines if another user, a third-party website 120, a mobile application 118 or another entity is allowed to access information associated with the user, including information about actions taken by the user. For example, the authorization server 235 uses a user's privacy setting to determine if the user's comment about a URL associated with the third-party website 120 can be accessed by the third-party website 120. This enables a user's privacy setting to specify which other users, or other entities, are allowed to receive data about the user's actions or other data associated with the user.

Additionally, the social networking system 130 maintains data about objects with which a user may interact with using the social networking system 130. To maintain this data, the user profile store 240 and the connection store 245 store instances of the corresponding type of objects maintained by the social networking system 130. Each object type has information fields that are suitable for storing information appropriate to the type of object. For example, the user profile store 240 contains data structures with fields suitable for describing a user's profile. When a new object of a particular type is created, the social networking system 130 initializes a new data structure of the corresponding type, assigns a unique object identifier to it, and begins to add data to the object as needed. This might occur, for example, when a user becomes a user of the social networking system 130, the social networking system 130 generates a new instance of a user profile in the user profile store 240, assigns a unique identifier to the user profile, and begins to populate the fields of the user profile with information provided by the user.

The connection store 245 includes data structures suitable for describing a user's connections to other users, connections to third-party websites 120 or connections to other entities. The connection stores 245 may also associate a connection type with a user's connections, which may be used in conjunction with the user's privacy setting, further described above, to regulate access to information about the user.

With the exception of computer gaming, moving competition online and into the realm of social networking has been a challenge. Thus, there exists a need for a framework for fostering and enabling competition between friends and even among strangers within social networks. The social competition engine described herein allows social networking system users to easily allow groups of friends to turn small competitions into “high stakes” competitive spectacles visible to their friends and family. These competitions provide a fertile setting for fostering social interactions and creating memories.

The social competition module 250 of the social networking system 130 enables users of the social networking system 130 to create, discuss, observe, document, and/or participate in competitions in an online, social environment. These competitions may be created by a user to challenge some of the user's friends or other users of the social networking system 130, or created by a group of users or an organization to challenge users of the social networking system 130. The competitions are documented in this online setting, and evidence of fulfillment of the stakes of the competition is further documented to create a lively social occurrence and sense of community.

Interactions between the users and the social networking system 130 including the social competition module 250 may occur using a web server 210 of the social networking system 130 that receives requests from web browser applications 112 of user devices and transmits markup language documents 116 (e.g., webpages) to be rendered by the web browser applications 112 of the user devices. In some embodiments of the invention, interactions between the users and the social networking system 130 including the social competition module 250 occur through a non-web browser application (e.g. mobile application 118) that executes on the user devices 110, which may communicate with one or more of the web server 210, API Request Server 220, Authorization Server 235, and social competition engine module 250. Thus, the following illustrative examples and figures may be implemented as part of a social networking website or as part of an application to be executed on user devices.

FIG. 3 is a sequence diagram illustrating a social competition enabled by a social competition engine module 250 of a social networking system 130 according to one embodiment of the invention. In this embodiment, a first user (using a first user device 310) challenges two other users (using a second user device 312 and a third user device 314) to a social competition. Other, non-participant users may observe, comment on, and help document the social competition through the posting of audio, photographic, or video content of the challenge or fulfillment of the challenge stakes. In the embodiment depicted in FIG. 3, one non-participant user is illustrated and represented by a fourth user device 318. In this figure, the actions represented by each arrow illustrate one possible sequence of events enabled by the social networking system 130. However, in embodiments of the invention different orderings of these actions may occur, and more or fewer actions may occur, without departing from the scope of the invention. Accordingly, these illustrated actions are not to be viewed as strictly necessary, but are merely illustrative of one possible use of the social networking system 130 and social competition engine module 250.

At 320, a first user device 310 transmits a challenge creation message 320 to the social networking system 130 including the social competition engine module 250. In an embodiment of the invention, the challenge creation message 320 includes a challenge indication, a challenge stakes indication, and a set of user identifiers. The challenge indication is a description of the challenge being made by the first user—an example of such a challenge may be “I challenge you to a chicken wing eating contest” or “The challenge is to raise $10,000 for the American Cancer Society by the end of the year.” The challenge stakes indication describes one or more of: an award for the winner of the challenge, a consequence for one or more of the losers of the challenge, or a blend of both. For example, the challenge stakes indication may include an award of “the winner gets to pick the movie we go to,” a consequence of “the losers have to wear an orange suit to work next Friday,” or a blend of both such as “the losers have to buy the winner a sushi dinner.” The set of user identifiers identify the other users of the social networking system 130 that are being challenged by the first user—here, the set of user identifiers may include a user identifier for the second user and a user identifier for third user. In other embodiments, the set of user identifiers may also include a user identifier of the challenging party—here, a user identifier of the first user.

In embodiments of the invention, the challenge creation message 320 may include many other items regarding the challenge. For example, the challenge creation message 320 may include a picture to be used with descriptions of the challenge, a location for the challenge to occur, a date and/or time for the challenge to occur and/or begin and/or end, a title for the challenge, etc.

At 322, upon receipt of the challenge creation message 320, the social networking system 130 may publish a challenge creation story or stories 322 within the social network. According to an embodiment of the invention, a challenge creation story includes content from the challenge creation message 320, including one or more of the challenge indication, the challenge stakes indication, the picture, the location for the challenge to occur, the dates and/or times for the challenge, and the title for the challenge. In an embodiment, the challenge creation story includes an indication of which user made the challenge (e.g., the first user) and an indication of one or more of the users that were challenged (e.g., the second user and/or the third user). The challenge creation story may also include a profile picture or image of the challenger user and/or the users that were challenged.

In an embodiment, the social networking system 130 publishes a challenge creation story for each of the users involved in the challenge, and this challenge creation story is displayed to one or more other users of the social networking system 130 not participating in the challenge (i.e. not included within the set of user identifiers). For example, the challenge creation story may be published in the social networking system 130 and associated with each of the challenge participants in such a manner that the “friends” (contacts, connections, etc.) of each participant are able to view (and interact with) the challenge creation story.

In the depicted embodiment of FIG. 3, the social networking system 130 transmits a challenge notification message 324 to the second user device 312 and a challenge notification message 326 to the third user device 314, thereby notifying the second and third user that they have been challenged by the first user. In embodiments of the invention, the challenge notification message may be an e-mail, text or SMS message, or instant message. In certain embodiments, the challenge notification message is an intra-social networking system message 130. In yet other embodiments, the social networking system 130 does not send the challenge notification message (324, 326) but instead is configured to enable the first user device 310 to directly transmit the challenge notification messages to the second user device 312 and third user device 314.

At 328, the second user, via the second user device 312, accepts the challenge and causes a challenge acceptance message 328 to be sent to the social networking system 130. In embodiments of the invention, the user can also change or increase the stakes of the challenge in this response or make a proposal to change the stakes. In response, the social networking system 130 publishes one or more challenge acceptance stories 330 indicating that the second user has accepted the challenge of the first user. As described above, these stories may be published such that one or more non-participants of the challenge are able to view (and possibly interact with) these stories.

At this point, the first user, through the first user device 310, makes a comment upon one of the challenge acceptance stories and causes a comment message 334 to be transmitted to the social networking system 130. Of course, the timing of this comment message 334 (and later comment messages) is not in any way required to occur at any point in time, aside from the need for a comment message 334 that comments upon a story to occur after that story occurs. Accordingly, assuming comment message 334 is in reply to one of the published challenge acceptance stories 330, comment message 334 could occur anywhere in FIG. 3 after the published acceptance stories 330 or need not occur at all.

At 336, the third user, via the third user device 314 accepts the challenge and causes a challenge acceptance message 328 to be sent to the social networking system 130. In response, the social networking system 130 publishes one or more challenge acceptance stories 338 indicating that the third user has accepted the challenge of the first user. At 332, the second user, via the second user device, makes a comment regarding one of the published stores (322, 330, or 338) and thereby causes a comment message 332 to be transmitted to the social networking system 130.

At a point in time, a beginning of the challenge 340 occurs in scenarios where the challenge has a definite date and time. However, in scenarios where no particular beginning or ending date for the challenge exists, the challenge may impliedly begin at the time of the challenge creation message 320. In those scenarios where the challenge has a beginning date and/or time, the social networking system 130 publishes one or more challenge occurrence stories 342 announcing the commencement of the challenge. At 344, a fourth user of the social networking system 130 posts a multimedia object to the social networking system 130 as part of a multimedia upload message 344. This multimedia object may be a photograph, video, or audio recording of one or more of the first user, second user, and third user as they participate in the challenge. For example, the multimedia object could be a picture of those users involved in a chicken wing eating contest at a restaurant sitting next to a pile of chicken wings. The fourth user, through the fourth user device 318, then transmits a comment message 346 to comment upon the challenge occurrence. It is anticipated that, in many embodiments, the multimedia upload 344 and comment 346 will be visible in the social networking system 130 by the challenge participants and countless other friends of the challenge participants, thereby leading to further discussion and online interaction.

When the challenge ends or after the challenge ends, the creator of the challenge (i.e. the first user) causes a challenge completion message 348 to be transmitted to the social networking system to announce the outcome of the challenge. In an embodiment, the challenge completion message 348 indicates the user identifier of the user that was a winner of the challenge. In response, the social networking system 130 may publish one or more challenge completion stories 350 indicating the result of the challenge. In other embodiments of the invention, the other participants of the challenge (312, 314) may also be allowed to cause a challenge completion message to be sent to indicate the outcome of the challenge. In some embodiments that are not illustrated herein, the participants of the challenge and/or the friends of the participants of the challenge are allowed to vote upon which of the participants should be the winner(s) or loser(s).

In some embodiments, responsive to receiving a challenge completion message (e.g. 348), the social network transmits a stakes verification request message (352, 354, 358) to one or more of the participants of the challenge requesting evidence indicating a fulfillment of the challenge stakes. These messages (352, 354, 358), depending upon the particular embodiment, may only be transmitted by the social networking system 130 to participants labeled as the winner in the challenge completion message 348, or may only be transmitted to participants deemed a loser of the challenge. In certain embodiments, these messages may also allow the sender to propose a “re-match” or “do-over” of the challenge.

At 358, the first user, via the first user device 310, transmits a stakes verification response message 358 to the social networking system 130, which includes evidence indicating that stakes involving the first user have been satisfied. For example, in a scenario where the challenge stakes requires any loser of the challenge to do 25 push-ups, the evidence might be a video or a still photograph of the first user doing the push-ups (provided the first user was deemed a loser of the challenge). As a result, the social networking system 130 will publish one or more stakes verification stories, which includes the evidence from the first user. Because of the compelling nature of such multimedia, especially with regard to the performance of an action satisfying a losing or winning stakes, significant interaction will typically occur among users of the social networking system 130. Accordingly, the fourth user, via the fourth user device 318, comments upon the stakes verification story 360 with comment message 362.

Similarly, the second user, via the second user device 312, transmits a stakes verification response message 364 to the social networking system 130 that includes evidence of the stakes fulfillment with respect to the second user. The social networking system 130 then publishes one or more stakes verification stories including the evidence from the second user. The third user, through the third user device 314, also transmits a stakes verification response message 368 including evidence of stakes fulfillment with respect to the third user, and the social networking system 130 publishes a set of one or more stakes verification stories 370. As described above, because of the competitive nature of these challenges, the fun or silly nature of the stakes, and the engrossing nature of multimedia evidence, substantial user interactions surrounding the challenge will occur within the social networking system 130 among its users privy to these stories. Accordingly, the fourth user, via the fourth user device 318 issues a comment message 372 with a comment about one of the stakes verification stories (360, 366, 370), leading to a response from the second user device 312 as another comment message 374. Despite the end of the challenge, such user interaction (e.g. comments, multimedia uploads, etc.) may continue for a substantial amount of time.

To support such social competition within the social networking system 130, new user interface modules are required. FIG. 4 illustrates a user device 400 displaying a user interface for creating a social challenge 450 according to one embodiment of the invention using a social networking system 130 including a social competition engine module 250. In this figure, a display of a user device 400 is depicted. This user device 400 may include a front-facing user device camera 332, a user device speaker 430, and a user device input button 434; however, many other features of the user device 400—visible from this perspective or invisible from this perspective—are not depicted to avoid distraction from aspects of the invention. In some embodiments, the user device 400 utilizes a touchscreen enabling a user to touch a portion of the screen to create user input; in other embodiments, the user device 400 utilizes a keyboard, mouse, eye-tracking system, or other hardware for receiving user input. The social challenge creation 450 interface illustrated may be implemented as part of a stand-alone mobile application 118 (e.g. native application) of the user device 400, or may be implemented using a markup language document 116 as part of a website viewed by the user device 400 using a browser application 112.

The social challenge creation interface 450 includes interface fields for a user device utilized when creating a challenge creation message (e.g., 320) to be transmitted to the social networking system 130. The social challenge creation interface 450 may include a challenge title field 402 allowing a user to input a title for the challenge, a challenge description image button/field 404 allowing the user to input an image to be used when displaying information about the challenge, and/or a challenge description field 406 allowing the user to describe what the challenge is to be. The social challenge creation interface 450 further may include a challenge stakes field 408 allowing the user to describe one or more of what the loser(s) of the challenge must do and what the winner(s) of the challenge gets. The user may also enter a date and/or time into a challenge time field 410 and a location into a challenge location field 412. The user may also invite one or more friends to participate in the challenge by clicking on an “invite friends” button 414, which leads to the interface described later in FIG. 5. Finally, the user may cancel the creation of the challenge by selecting the cancel button 416 or create the challenge by selecting the create challenge button 418. In some embodiments, the selection of the create challenge button 418 results in the user device 400 transmitting a challenge creation message 320 to the social networking system 130.

FIG. 5 illustrates a user device 400 displaying a user interface for inviting friends to a join a social challenge according to one embodiment of the invention using a social networking system 130 including a social competition engine module 250. This user interface, in an embodiment, is displayed after a user selects the “invite friends” button 414 of the social challenge creation interface 450 of FIG. 4. This interface includes a user search input 502, which allows for a user to quickly search through a set of friends to easily find a friend that should be invited to participate in the challenge. The interface also includes a set of users 504A-504N. Each user is represented by a user icon 506 of the user, which in some embodiments is a thumbnail of a photograph of that user. The user is further represented by their user name 508. A user is selected for inclusion in the list of requested challenge participants by selecting that user with a user selector input 510. One or more users 504A-504N may be selected for inclusion in this list.

FIG. 6 illustrates a user device 400 displaying a user interface for a social challenge notification according to one embodiment of the invention using a social networking system 130 including a social competition engine module 250. The user interface includes a user competition profile 602, which includes the user's name, a number of challenges that the user has won, and a number of challenges that the user has lost. Next, the user interface includes details about a particular challenge—in the depicted user interface a challenge titled the “GCM KARAOKE” challenge is illustrated. This challenge includes a challenge description image 404, a challenge description 406, a challenge time 410, a challenge location 412, and a challenge participant summary 604. In an embodiment, the challenge participant summary 614 presents user icons for each of the users invited to participate in that challenge. These user icons may be augmented (e.g. shaded out, crossed out) if that respective user has declined the invitation to participate in the challenge. In another embodiment, the challenge participant summary 614 only includes user icons of those users that have agreed to participate in the challenge (i.e. transmitted challenge acceptance messages (e.g., 328)). The user interface also includes a social commentary summary 604. In this embodiment, the social commentary summary 604 includes a comment icon and comment count, which indicates how many users have commented on the challenge, and further includes a like icon and like count, which indicates how many users have “liked” the challenge (i.e., indicated their positive opinion of the challenge). The user interface further includes a challenge acceptance input button 608 and a challenge refusal input button 610, which allow the user to accept the invitation to participate in the challenge or refuse the invitation to participate in the challenge, respectively. In an embodiment, a selection of the challenge acceptance input button 608 causes the user device 400 to transmit a challenge acceptance message (e.g. 336) to the social networking system 130, and a selection of the challenge refusal input button 610 causes the user device 400 to transmit a challenge refusal acceptance message (not depicted). The user interface further includes a recommended challenges 612 portion, which recommends other existing challenges that the user is qualified to participate in, perhaps by being specifically invited to participate or by the challenge being open to any user.

FIG. 7 illustrates a user device 400 displaying a user interface for a social challenge according to one embodiment of the invention. Similar to FIG. 6, the user interface of FIG. 7 includes a challenge summary 702 indicating the challenge title, a challenge description image 406, a challenge description 406, a social commentary summary 604, and a challenge participant summary 614. However, this user interface also depicts a challenge comment 704A made about the challenge. The challenge comment 704A includes a sentence of text, as a challenge video 706 that documents part of the challenge, and a cheering panel 708 indicating how many users like (“WOO!”) or dislike (“BOO!”) the video. In an embodiment, the user viewing this user interface is able to use the cheering panel 708 to like or dislike the video by selecting either the word “WOO!” or “BOO!”. Another challenge comment 704B is also depicted that includes some text.

FIG. 8 illustrates a user device 400 displaying a user interface for a winner of a social challenge according to one embodiment of the invention using a social networking system 130 including a social competition engine module 250. The user interface includes a user competition profile of the user including the user's name, challenge win count, and challenge loss count. The user interface also includes a challenge winner display 802, which indicates that the user has won the challenge. The challenge winner display 802 further includes a winning stakes verification input button 804 that allows the user to verify that the winning stakes has been collected. In some embodiments, selection of the winning stakes verification input button 804 allows the user to post evidence of the satisfaction of the winning stakes in the form of a picture, audio recording, or video. The submission of this evidence, in some embodiments, causes the user device 400 to transmit a stakes verification request message (e.g. 358). The user interface also includes a social commentary summary 604 indicating the number of comments and “likes” about the challenge (or about this story indicating the winner of the challenge). The user interface further includes a recommended challenges panel 612 indicating other challenges that the user may participate in.

FIG. 9 illustrates a user device 400 displaying a user interface for a loser of a social challenge according to one embodiment of the invention using a social networking system 130 including a social competition engine module 250. Similar to FIG. 6 and FIG. 8, the user interface includes a user competition profile 602 and a recommended challenges panel 612. However, the user interface of FIG. 9 includes a challenge loser display 902 indicating that the user is a loser of the challenge and includes a losing stakes verification input button 904. The losing stakes verification input button 904 allows the user to indicate that the losing stakes have been completed. In an embodiment, the selection of the losing stakes verification input button 904 enables the user to post evidence of the satisfaction of the losing stakes in the form of a picture, audio recording, or video. The submission of this evidence, in some embodiments, causes the user device 400 to transmit a stakes verification request message (e.g. 358). The user interface also includes a social commentary summary 604 indicating the number of comments and “likes” about the challenge (or about this story indicating the loser of the challenge).

FIG. 10 illustrates a plurality of social graph stories in a social networking system 130 according to one embodiment of the invention. The first story, a social graph challenge creation story 1002A, is depicted as viewed from the newsfeed of a challenge creator. The headline of the social graph challenge creation story 1002A is “Keenan Pridmore challenged Chris Barbour and P J MacGregor on Game On”, and includes a social graph action 1004 of “challenged”. The social graph challenge creation story 1002A further includes the challenge description 406 and challenge stakes 408, and allows a viewing user to “Like” the story or comment on the story. The second social graph challenge creation story 1002B illustrates the creation of the same challenge, except from the standpoint of a friend's newsfeed, as indicated by the headline “Chris Barbour and P J MacGregor have been challenged by Keenan Pridmore on Game On.” Both of these stories 1002A and 1002B, in an embodiment, are the published challenge creation stories 322 of FIG. 3.

FIG. 10 also illustrates two social graph stakes verification stories (1002C, 1002D). The third story of FIG. 10 is a social graph stakes verification story 1002C as viewed from a challenge loser's newsfeed. Although the social graph stakes verification story 1002C appears similar to the two social graph stories displayed above, this story 1002C includes a challenge verification comment 1006 made by the loser and challenge verification evidence 1008 in the form of a photograph. In this illustrated example, the challenge stakes were that “Losers have to buy the first rounds,” so the challenge verification evidence 1008 may be a photograph of a beverage purchased as fulfillment of those stakes. The fourth, social graph stakes verification story 1002C of FIG. 10 illustrates the same information, but from the standpoint of a friend's newsfeed. Both of these stories 1002C and 1002D, in an embodiment, are the published stakes verification stories (e.g. 366) of FIG. 3.

FIG. 11 illustrates a social graph challenge completion story 1102 and a challenge proposal story 1104 in a social networking system 130 according to one embodiment of the invention. The social graph challenge completion story 1102 indicates the result of a challenge titled “Best Beard at da Bar” made by a hosted challenge entity 1106—here, a “Schoolyard Tavern.” A hosted challenge entity 1106 is a venue or organization that is able to create a challenge a set of stakes, but depending upon the embodiment does not participate as a participant in the challenge or select a set of participants to be invited to participate in the challenge. For example, a user can participate in the challenge without having been invited/selected by the challenge creator. FIG. 11 also illustrates a challenge proposal story 1104 by a hosted entity—the challenge reads in part “Today's Game On Challenge is: Get a standing ovation at karaoke. The stakes: The 10 most liked videos will receive a special prize!” Thus, a list of invited participants is not utilized and the challenger (here, an unnamed hosted entity) will not directly participate as a participant in the challenge.

FIG. 12 illustrates a flow for enabling social competition between users of a social networking system 130 according to one embodiment of the invention. In embodiments of the invention, the users involved in the competition enabled in FIG. 12 are individual persons. The operations of this and other flow diagrams will be described with reference to the exemplary embodiments of the other diagrams. However, it should be understood that the operations of the flow diagrams can be performed by embodiments of the invention other than those discussed with reference to these other diagrams, and the embodiments of the invention discussed with reference these other diagrams can perform operations different than those discussed with reference to the flow diagrams.

At 1202, a social networking system 130 receives, from a user device of a first user of the social networking system, a challenge creation request message. The challenge creation request message includes a challenge indication that describes a competition that the first user and a first set of one or more users of the social networking system may participate in. The challenge creation request message also includes a challenge stakes indication that describes at least one an award for a winner of the competition and a consequence for losers of the competition. The challenge creation request message may further include a set of user identifiers for the first set of users.

The social networking system 130 notifies each of the first set of users about the competition 1204. In embodiments of the invention, this notification may be posting information to a user page or newsfeed of each of the first set of users of the social networking system 130, or transmitting a private message to each of the users (through the social networking system 130 as part of a web page or application screen, or through an Instant Messaging protocol or email message, etc.). The social networking system 130 then receives one or more challenge acceptance messages from one or more user devices utilized by one or more of the first set of users 1206. Each challenge acceptance message indicates that the respective user will participate in the competition.

The social networking system 130 receives a challenge completion message indicating the winner of the competition 1208 and receives evidence indicating a fulfillment of the challenge stakes 1210. Finally, the social networking system 130 transmits information about the competition to a set of one or more user devices of a second set of users of the social networking system 1212.

FIG. 13 illustrates a flow for enabling social competition for a user of a social networking system 130 according to one embodiment of the invention. In embodiments of the invention, the challenge of FIG. 13 is created by a non-human entity (e.g. company, organization, corporation, etc.) and the users attempting to fulfill the challenge are individual persons. Exemplary uses of this flow include providing a challenge to a user in a particular location such as in a bar, stadium, etc., associating a challenge with a particular product such as a purchase of soda, beer, chips, etc., visiting a website, etc. At 1302, a social networking system 130 transmits an indication of a challenge to a user device of a user. The indication is to be displayed by the user device to the user. The indication includes a challenge description that describes the challenge that the user and other users of a social networking system may participate in. The indication also includes a challenge stakes description that describes an award for a winner of the challenge. This challenge may be transmitted upon the user being currently or previously physically located in a location (such as a bar, stadium, store, etc.), as a result of the user initiating a challenge based upon directions included in a purchase (such as typing-in a code included with a purchased item, e.g., a code on a soda bottle), or simply by the user visiting a website.

In some embodiments, the social networking system 130 receives, from the user device of the user, a challenge acceptance message indicating that the user has accepted the challenge. Then, in some embodiments, the social networking system 130 transmits to at least some of the plurality of user devices an indication that the user has accepted the challenge 1306. This indication is to be displayed by the at least some of the plurality of user devices.

The social networking system 130 then receives, from a user device of the user, evidence indicating that the user has fulfilled the challenge 1308. Next, the social networking system 130 transmits the evidence to a plurality of user devices of a plurality of users of the social networking system 1310. The evidence is to be displayed by the plurality of user devices to the plurality of users.

Finally, in some embodiments, the social networking system 130 transmits to at least some of the plurality of user devices an indication that the user is the winner of the challenge 1312. This indication is to be displayed by the plurality of user devices.

FIG. 14 illustrates, in block diagram form, an exemplary processing system 1400 to provide social competition functionalities. Data processing system 1400 includes one or more microprocessors 1405 and connected system components (e.g., multiple connected chips). Alternatively, the data processing system 1400 is a system on a chip.

The data processing system 1400 includes memory 1410, which is coupled to the microprocessor(s) 1405. The memory 1410 may be used for storing data, metadata, and programs for execution by the microprocessor(s) 1405. The memory 1410 may include one or more of volatile and non-volatile memories, such as Random Access Memory (RAM), Read Only Memory (ROM), a solid state disk (SSD), Flash, Phase Change Memory (PCM), or other types of data storage. The memory 1410 may be internal or distributed memory.

The data processing system 1400 also includes an audio input/output subsystem 1415 which may include a microphone and/or a speaker for, for example, playing back music or other audio, receiving voice instructions to be executed by the microprocessor(s) 1405, playing audio notifications, etc.

A display controller and display device 1420 provides a visual user interface for the user, e.g., GUI windows illustrated in FIGS. 4-11.

The data processing system 1400 also includes one or more input or output (I/O) devices and interfaces 1425, which are provided to allow a user to provide input to, receive output from, and otherwise transfer data to and from the system. These I/O devices 1425 may include a mouse, keypad or a keyboard, a touch panel or a multi-touch input panel, camera, optical scanner, network interface, modem, other known I/O devices or a combination of such I/O devices. The touch input panel may be a single touch input panel which is activated with a stylus or a finger or a multi-touch input panel which is activated by one finger or a stylus or multiple fingers, and the panel is capable of distinguishing between one or two or three or more touches and is capable of providing inputs derived from those touches to the processing system 1400.

The I/O devices and interfaces 1425 may also include a connector for a dock or a connector for a USB interface, FireWire, Thunderbolt, Ethernet, etc. to connect the system 1400 with another device, external component, or a network. Exemplary I/O devices and interfaces 1425 also include wireless transceivers, such as an IEEE 802.11 transceiver, an infrared transceiver, a Bluetooth transceiver, a wireless cellular telephony transceiver (e.g., 2G, 3G, 4G), or another wireless protocol to connect the data processing system 1400 with another device, external component, or a network and receive stored instructions, data, tokens, etc.

It will be appreciated that one or more buses may be used to interconnect the various components shown in FIG. 14.

The data processing system 1400 is an exemplary representation of a user device 110, but any of these features may also be utilized by devices implementing the social networking system 130. The data processing system 1400 may be a personal computer, tablet-style device, a personal digital assistant (PDA), a cellular telephone with PDA-like functionality, a Wi-Fi based telephone, a handheld computer which includes a cellular telephone, a media player, an entertainment system, or devices which combine aspects or functions of these devices, such as a media player combined with a PDA and a cellular telephone in one device. In other embodiments, the data processing system 1400 may be a network computer, server, or an embedded processing device within another device or consumer electronic product. As used herein, the terms computer, system, device, processing device, and “apparatus comprising a processing device” may be used interchangeably with the data processing system 1400 and include the above-listed exemplary embodiments.

It will be appreciated that additional components, not shown, may also be part of the system 1400, and, in certain embodiments, fewer components than that shown in FIG. 14 may also be used in a data processing system 1400. It will be apparent from this description that aspects of the inventions may be embodied, at least in part, in software. That is, the computer-implemented methods may be carried out in a computer system or other data processing system in response to its processor or processing system executing sequences of instructions contained in a memory, such as memory 1410 or other non-transitory machine-readable storage medium. The software may further be transmitted or received over a network (not shown) via a network interface device 1425. In various embodiments, hardwired circuitry may be used in combination with the software instructions to implement the present embodiments. Thus, the techniques are not limited to any specific combination of hardware circuitry and software, or to any particular source for the instructions executed by the data processing system 1400.

An article of manufacture may be used to store program code providing at least some of the functionality of the embodiments described above. Additionally, an article of manufacture may be used to store program code created using at least some of the functionality of the embodiments described above. An article of manufacture that stores program code may be embodied as, but is not limited to, one or more memories (e.g., one or more flash memories, random access memories—static, dynamic, or other), optical disks, CD-ROMs, DVD-ROMs, EPROMs, EEPROMs, magnetic or optical cards or other type of non-transitory machine-readable media suitable for storing electronic instructions. Additionally, embodiments of the invention may be implemented in, but not limited to, hardware or firmware utilizing a Field-Programmable Gate Array (FPGA), Application-Specific Integrated Circuit (ASIC), a processor, a computer, or a computer system including a network. Modules and components of hardware or software implementations can be divided or combined without significantly altering embodiments of the invention.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

It will be evident that various modifications may be made thereto without departing from the broader spirit and scope of the invention as set forth in the following claims. For example, the methods described herein may be performed with fewer or more features/blocks or the features/blocks may be performed in differing orders. Additionally, the methods described herein may be repeated or performed in parallel with one another or in parallel with different instances of the same or similar methods.

What is claimed is:

1. A method comprising:
receiving, from a user device of a first user of a social networking system, a challenge creation request message comprising:
a challenge indication that describes a competition that the first user and a first set of one or more users of the social networking system may participate in,
a challenge stakes indication that describes at least one of an award for a winner of the competition and a consequence for losers of the competition, and
a set of user identifiers for the first set of users;
notifying each of the first set of users about the competition;
receiving one or more challenge acceptance messages from one or more user devices utilized by one or more of the first set of users, wherein each challenge acceptance message indicates that the respective user will participate in the competition;
receiving a challenge completion message indicating the winner of the competition;
receiving evidence indicating a fulfillment of the challenge stakes; and
transmitting information about the competition to one or more user devices of a second set of one or more users of the social networking system.

2. The method of claim 1, wherein the second set of users comprises:
the first user;
the first set of users; and
at least one other user of the social networking system.

3. The method of claim 2, further comprising:
receiving, from a second user device of the at least one other user, a challenge comment message including a comment made about the competition; and
transmitting the comment to at least one of the user devices of the second set of users to be displayed to those respective users.

4. The method of claim 1, wherein said information is the evidence indicating the fulfillment of the challenge stakes.

5. The method of claim 4, wherein said evidence is one of a video and a photograph.

6. The method of claim 1, further comprising:
receiving, from a second user device of one of the first set of users, a challenge refusal message indicating that the one of the first set of users will not participate in the competition.

7. A method comprising:
transmitting an indication of a challenge to a user device of a user, wherein the indication is to be displayed by the user device to the user, the indication comprising:
a challenge description that describes the challenge that the user and other users of a social networking system may participate in, and
a challenge stakes description that describes an award for a winner of the challenge;
receiving, from the user device of the user, evidence indicating that the user has fulfilled the challenge; and
transmitting the evidence to a plurality of user devices of a plurality of users of the social networking system, wherein the evidence is to be displayed by the plurality of user devices to the plurality of users.

8. The method of claim 7, further comprising:
receiving, from the user device of the user, a challenge acceptance message indicating that the user has accepted the challenge.

9. The method of claim 8, further comprising:
transmitting to at least one of the plurality of user devices an indication that the user has accepted the challenge, wherein the indication is to be displayed by the at least one of the plurality of user devices.

10. The method of claim 7, wherein said evidence is one of a video and a photograph.

11. The method of claim 7, further comprising:
transmitting to at least one of the plurality of user devices an indication that the user is the winner of the challenge, wherein the indication is to be displayed by the at least one of the plurality of user devices.

12. A social networking system comprising:
a communications interface to transmit and receive messages to and from a plurality of user devices of a plurality of users of a social networking system;
a social competition engine module to utilize the communications interface to:
receive, from a user device of a first user of the plurality of users, a challenge creation request message comprising:
a challenge indication that describes a competition that the plurality of users may participate in,
a challenge stakes indication that describes at least one of an award for a winner of the competition and a consequence for losers of the competition, and
a set of user identifiers for a set of users including those of the plurality of users that are not the first user;
notify each user of the set of users about the competition;
receive one or more challenge acceptance messages from one or more user devices utilized by one or more of the first set of users, wherein each challenge acceptance message indicates that the respective user will participate in the competition;
receive a challenge completion message indicating the winner of the competition;
receive evidence indicating a fulfillment of the challenge stakes;
transmit information about the winner of the competition to a set of one or more user devices of at least one of the plurality of users, wherein the information is to be displayed by the set of user devices; and
transmit the evidence indicating the fulfillment of the challenge stakes to each of the set of user devices, wherein the evidence is to be displayed by the set of user devices.

13. The social networking system of claim 12, wherein the social competition engine further utilizes the communications interface to:
transmit, to a second user device of another user of the social networking system that is not of the plurality of users, the information about the winner of the competition, wherein the information is to be displayed by the second user device.

14. The social networking system of claim 13, wherein the social competition module further utilizes the communications interface to:
receive, from the second user device of said another user, a challenge comment message including a comment made about the competition; and
transmit the comment to at least one of the set of user devices, wherein the comment is to be displayed by the at least one of the set of user devices.

15. The social networking system of claim 12, wherein said evidence is one of a video and a photograph.

16. The social networking system of claim 12, wherein the social competition module further utilizes the communications interface to:
receive, from a second user device of one of the set of users, a challenge refusal message indicating that the one of the set of users will not participate in the competition.

17. A social networking system comprising:
a communications interface to transmit and receive messages to and from a plurality of user devices of a plurality of users of a social networking system;
a social competition engine module to utilize the communications interface to:
transmit an indication of a challenge to a user device of the user, wherein the indication is to be displayed by the user device to the user, wherein the indication comprises:
a challenge description that describes the challenge that the user and other users of the social networking system may participate in, and
a challenge stakes description that describes an award for a winner of the challenge,
receive, from the user device of the user, evidence indicating that the user has fulfilled the challenge, and
transmit the evidence to a plurality of user devices of a plurality of users of the social networking system, wherein the evidence is to be displayed by the plurality of user devices to the plurality of users.

18. The social networking system of claim 17, wherein the social competition module further utilizes the communications interface to:
receive, from the user device of the user, a challenge acceptance message indicating that the user has accepted the challenge.

19. The social networking system of claim 18, wherein the social competition module further utilizes the communications interface to:
transmit to at least one of the plurality of user devices an indication that the user has accepted the challenge, wherein the indication is to be displayed by the at least one of the plurality of user devices.

20. The social networking system of claim 17, wherein said evidence is one of a video and a photograph.

21. The social networking system of claim 17, wherein the social competition module further utilizes the communications interface to:
transmit to at least one of the plurality of user devices an indication that the user is the winner of the challenge, wherein the indication is to be displayed by the at least one of the plurality of user devices.
